(19) United States
(12) Patent Application Publication
(10) Pub. No.: US 2009/0230220 A1
(43) Pub. Date: Sep. 17, 2009

(54) INJECTOR FOR A FUEL INJECTION SYSTEM

(76) Inventors: Michael Mennicken, Wimsheim (DE); Hans-Christoph Magel, Reutlingen (DE); Matthias Burger, Murr (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/306,054

(22) PCT Filed: Jun. 4, 2007
(86) PCT No.: PCT/EP07/55449

§ 371 Date: Dec. 22, 2008

(30) Foreign Application Priority Data
Aug. 4, 2006 (DE) 10 2006 036 447.3

(51) Int. Cl. F02M 51/00

(52) U.S. Cl. 239/585.5

(57) ABSTRACT

A leak-free injector is proposed, the closing force of which is increased by a closing piston. An injector has a nozzle needle and a control valve, the nozzle needle being guided in an injector housing and cooperating with a nozzle needle seat of the injector housing. A high-pressure chamber is present between the control valve and the nozzle needle seat, and the closing piston is provided on the nozzle needle. The closing piston subdivides the high-pressure chamber into a first region and a second region. The two regions of the high-pressure chamber communicate hydraulically via a closing throttle restriction.

### PRIOR ART

The invention is based on an injector for an injection system of an internal combustion engine, having a nozzle needle and a control valve, as known for instance from German Patent Disclosure DE 10 2004 058 184.3.

### DISCLOSURE OF THE INVENTION

To improve emissions from internal combustion engines still further, it is necessary to increase the injection pressure. To keep the amount of leakage low in that situation, injectors are used whose nozzle needle has no pressure step, so that the entire nozzle needle is surrounded by fuel that is at rail pressure. As a result, only slight closing forces are available, which leads to problems in metering small injection quantities, since the performance graphs of such injectors are very steep.

The object of the invention is to furnish an injector which makes a sufficiently high closing force available even though the nozzle needle is embodied without a pressure step.

In an injector for an injection system of an internal combustion engine, having a nozzle needle and having a control valve, the nozzle needle being guided in an injector housing and cooperating with a nozzle needle seat of the injector housing, and a high-pressure chamber being present between the control valve and the nozzle needle seat, this object is attained according to the invention in that a closing piston is provided on the nozzle needle or on a control piston; that the closing piston subdivides the high-pressure chamber into a first region and a second region; and that the two regions of the high-pressure chamber communicate hydraulically by means of a closing throttle restriction.

By means of the closing piston according to the invention and the closing throttle restriction, the closing force engaging the nozzle needle and the control piston during the closing motion is increased because the effective pressure area is increased.

Because of the increased pressure area, the pressure difference required for furnishing a sufficiently high closing force can be reduced. Consequently, given a suitable design of the injector of the invention or of the closing piston and/or the closing throttle restriction, it is also possible to increase the needle closing speed and to reduce the steepness of the performance graph.

In an advantageous feature of the invention, the closing piston is guided in the radial direction in the injector housing; and that between the closing piston and the nozzle needle, there is play in the radial direction. As a result, a complicated double guidance of the nozzle needle and control piston with the resultant production costs can be avoided. Moreover, it is assured that seizing of the nozzle needle from an axial offset between the guidance of the nozzle needle and the guidance of the closing piston in the injector housing will not occur.

It has proved especially advantageous if the closing piston has a slit, and this slit is simultaneously embodied as a closing throttle restriction.

In this embodiment, the closing piston can be guided, similarly to a piston ring of an internal combustion engine, with a certain prestressing in the injector housing, so that even with increasing wear of the injector and closing piston, play-free guidance of the closing piston in the injector housing is always assured. Simultaneously, if the slit is suitably dimensioned, it acts as a closing throttle restriction. As a result, the closing throttle restriction can be furnished without additional production effort and expense.

Alternatively, it is understood also to be possible to provide a throttle bore in the closing piston, or to adjust the desired throttling action by way of the play between the closing piston and the injector housing.

To make it possible to attain the advantages of the invention, the outside diameter of the closing piston is greater than the diameter of the nozzle needle in the region of the nozzle needle guide.

In a further advantageous feature of the injector, the control valve, in a first switching position, interrupts a hydraulic communication between a control chamber and a fuel return, while in a second switching position, it establishes a hydraulic communication between the control chamber and a fuel return.

The control piston defines a control chamber and is coupled with the nozzle needle.

It has furthermore proved advantageous if the control piston has a through bore, and on an end toward the control chamber it has a sealing edge that surrounds the through bore, and a flat seat cooperating with the sealing edge is embodied on the control chamber body.

It is structurally easily possible for the valve body and the control chamber body to be embodied in one piece. It is equally possible to embody the control piston and the nozzle needle in one piece.

Further advantages and advantageous embodiments can be learned from the following drawings, their description and the claims. All the characteristics described in the drawings, in their description, and in the claims can be essential to the invention, both individually and in arbitrary combination with one another.

### BRIEF DESCRIPTION OF THE DRAWINGS

Shown are:

FIG. 1, the schematic illustration of a common rail injection system;

FIG. 2, a first exemplary embodiment of an injector according to the invention;

FIG. 3, a second exemplary embodiment of an injector according to the invention; and

FIG. 4, a plan view on one exemplary embodiment of a closing piston.

### EMBODIMENTS OF THE INVENTION

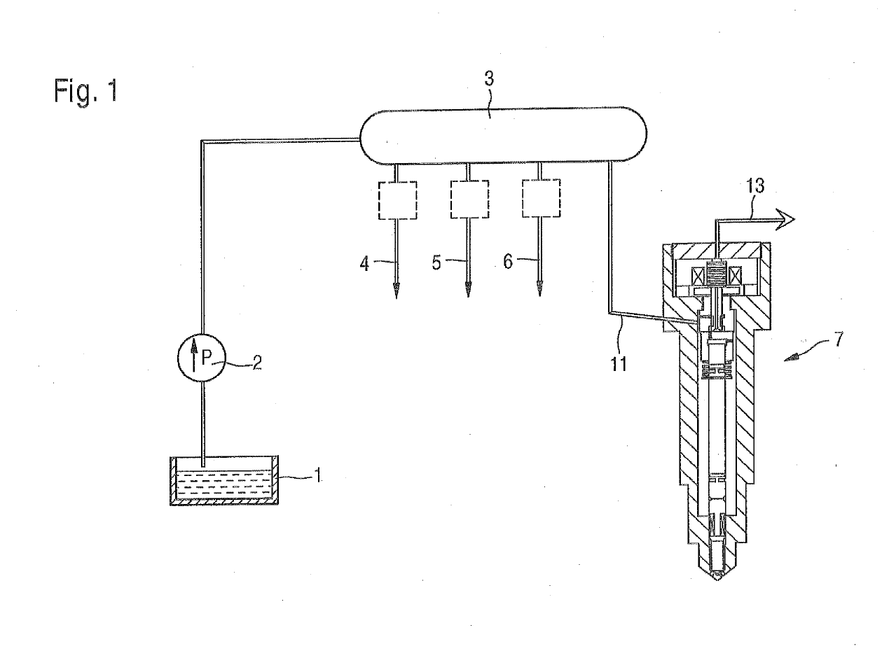

In FIG. 1, a common rail injection system is shown schematically. From a fuel tank 1, fuel is pumped with the aid of a pump unit 2 into a high-pressure fuel reservoir 3 and subjected to high pressure. The fuel subjected to high pressure is then allocated as a function of demand to the individual cylinders of the internal combustion engine to be supplied. The injection of the fuel subjected to high pressure is effected through injectors 4, 5, 6 and 7. In FIG. 1, only the injector 7 is shown, for the sake of simplicity.

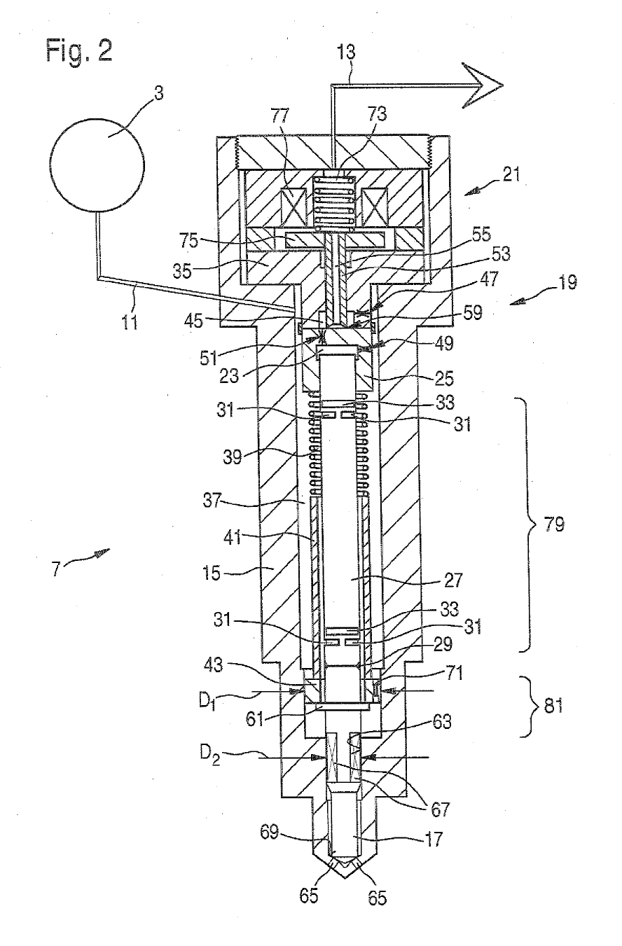

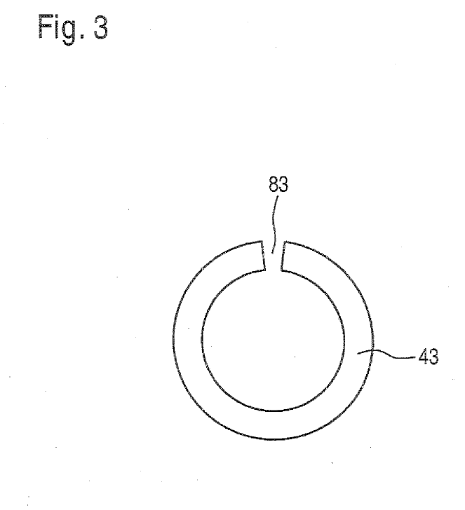

The injector 7 communicates with the common rail 3 via a high-pressure connection 11. The injector 7 moreover communicates hydraulically with the tank 1 via a fuel return 13, which is virtually pressureless. The injector 7 will be described in further detail below in conjunction with FIGS. 2 and 3.

The injector 7 includes a housing 15, in which a nozzle needle 17 is guided. A control valve 19 according to the invention and an electromagnetic actuator 21 are disposed on the end, remote from the combustion chamber, of the injector 7.

Below the control valve 19, a control chamber 23 is embodied in a control chamber body 25. The control chamber 23 is defined by a control piston 27.

In the present exemplary embodiment, the control piston 27 is joined to the nozzle needle 17 by a weld seam 29. It is understood that the possibility also exists of embodying the control piston 27 and the nozzle needle 17 in one piece.

To compensate for errors of alignment between the control chamber 23 and the nozzle needle 17, the cross section of the control piston 27 is reduced in some regions. This reduction in the cross section is effected in the exemplary embodiment shown in FIG. 2 by two grooves 31 and 33, and the grooves 31 and 33 are offset from one another by an angle of 90°. The grooves 31 and 33 reduce the bending stiffness of the control piston 27 and function similarly to a cardan joint.

In the exemplary embodiment shown in FIG. 2, a first pair of grooves 31 and 33 is provided below the control chamber body 25, while a second pair of grooves 31 and 33 is provided above the nozzle needle 17. By the cooperation of the two “cardan joints” formed by the grooves 31 and 33, errors of alignment between the control chamber 23 and the nozzle needle 17 can be compensated for especially well.

In the exemplary embodiment shown in FIG. 2, the control chamber body 25 and a valve body 35 of the control valve 19 are embodied as separate components. It is alternatively possible to embody the valve body 35 and the control chamber body 25 in one piece.

Both the control chamber body 25 and part of the valve body 35 are located in a high-pressure chamber 37 in the injector 7. The high-pressure connection 11 discharges into the high-pressure chamber 37 and is directly in communication hydraulically with the common rail injection system 3. This means nothing other than that the rail pressure prevails in the high-pressure chamber 37. The high-pressure chamber 37 can also take on the function of a pressure reservoir.

The control chamber body 25 is pressed against the valve body 35 via a closing spring 39. The closing spring 39 furthermore serves to press the nozzle needle 17 against a nozzle needle seat 69, when the injector is pressureless. For that purpose, there is a sleeve 41, which rests on a closing piston 43. An annular chamber 45 is embodied in the valve body 35. This annular chamber 45 is in communication hydraulically with the high-pressure chamber 37, via a bore 47 that can also be embodied as a throttle restriction.

The control chamber 23 and the high-pressure chamber 37 communicate hydraulically with one another via an inflow throttle restriction 49. The control chamber 23 and the annular chamber 45 communicate hydraulically with one another via an outflow throttle restriction 51.

A control piston 53 has a through bore 55, which is hydraulically in communication with the fuel return 13 (see FIG. 2).

One face end of the control chamber body 25 is embodied as a flat seat. This flat seat cooperates with a sealing edge 59, disposed on the end of the control piston 53 toward the valve body 25.

The closing piston 43 is braced in the closing direction of the nozzle needle 17 against a shoulder 61 of the nozzle needle 17. Simultaneously, the shoulder 61 forms a sealing seat that cooperates with the closing piston 43. The sealing seat, in the exemplary embodiment of FIG. 1, is embodied as a flat seat. A flat seat is especially advantageous in the present case, since the closing piston is guided in the radial direction not by the sealing seat but solely in the injector housing 15.

Below this shoulder 61, the nozzle needle 17 is guided axially displaceably in a nozzle needle guide 63. So that fuel from the upper part of the high-pressure chamber 37 can reach the injection ports 65 of the injector 7, a plurality of flattened faces 67 are provided on the nozzle needle 17, in the region of the nozzle needle guide 63

The injection ports 65 are disposed in a nozzle needle seat 69 such that they are closed when the nozzle needle 17 rests on the nozzle needle seat 69.

In the exemplary embodiment shown in FIG. 2, there is a closing throttle restriction 71 in the form of a longitudinal bore in the closing piston 43.

The closing piston 43 is guided in the injector housing 15. The diameter of the injector housing, in the region in which the closing piston 43 is guided, is given as D₁ in FIG. 2. The diameter of the nozzle needle guide 63 is marked D₂ in FIG. 1. Comparing the diameters D₁ and D₂ clearly shows that the diameter D₁ of the closing piston 43 is greater than the diameter D₂ of the nozzle needle guide 63 (D₁>D₂).

The injector 7 according to the invention functions as follows:

In the first switching position, shown in FIG. 2, the actuator 21 is not being supplied with current, so that a compression spring 73, which acts on an armature plate 75 and thus also on the control piston 53, presses the control piston 53 against the control chamber body 25. As a result, the hydraulic communication between the control chamber 23 and the fuel return 13 is closed, Consequently, rail pressure prevails in the control chamber 23, and the nozzle needle 17 is closed.

As soon as an electromagnet 77 of the electric actuator is supplied with current, the armature plate 75 is drawn upward in FIG. 2, so that the sealing edge 59 of the valve body 43 lifts from the control chamber body 25, and thus a hydraulic communication is established between the control chamber 23 and the fuel return 13, via the outflow throttle restriction 55 and the through bore 57 in the valve body 43.

Since the outflow throttle restriction 55 has a lesser flow resistance than the inflow throttle restriction 53, the pressure in the control chamber drops in this second switching position of the control valve 8. As a consequence, the nozzle needle 17 lifts from its nozzle needle seat 69, and fuel is injected into the combustion chamber of an internal combustion engine. Since the closing piston 43 moves upward in FIG. 2 along with the nozzle needle 17 as soon as the nozzle needle 17 opens, fuel flows from a first region 79 of the high-pressure chamber 37 through the closing throttle restriction 71 into a second region 81 of the high-pressure chamber 37. Because of the flow resistance of the closing throttle restriction 71, the opening motion of the nozzle needle is slowed somewhat. By a suitable adaptation of the inflow throttle restriction 49, outflow throttle restriction 51, and if present the bore 47, however, this effect can be compensated for entirely or in part.

As long as the nozzle needle 17 is open, fuel flows out of the first region 79 of the high-pressure chamber 37 via the closing throttle restriction 71 and the second region 81 of the high-pressure chamber 37 into the combustion chamber of the engine through the injection ports 65. As a consequence, a certain pressure reduction takes place in the closing throttle restriction 71. The pressure forces exerted on the closing piston 43 by the fuel located in the first region 79 of the high-pressure chamber 37 are therefore greater than the pressure forces exerted on the closing piston 43 by the fuel located in the second region 81 of the high-pressure chamber 37. The resultant force is oriented downward in FIG. 2, that is, in the closing direction of the nozzle needle 17. This force is also operative during the closure of the nozzle needle 17. Since the effective area of the closing piston 43 is relatively large, a slight pressure drop at the closing throttle restriction 71 suffices to furnish a sufficiently strong closing force. This slight pressure drop has no effect, or only a very slight effect, on the atomization of the fuel in the injection ports 65.

When the injection is to be terminated, the electromagnet 77 is switched to be currentless. As a consequence, the control piston 43 moves downward in FIG. 2, until the sealing edge 59 rests on the face end of the control chamber body 25. As a result, the hydraulic communication between the control chamber 23 and the fuel return 13 is undone again, and fuel at high pressure can flow into the control chamber 23 via the inflow throttle restriction 53.

If the bore 47 is present, then fuel can flow into the control chamber 23 via the outflow throttle restriction 55 as well. As a consequence, the nozzle needle 17 is again pressed against its nozzle needle seat.

Because the closing piston 43 has a large cross-sectional area, whose outside diameter is equivalent to the diameter D₁, a slight pressure drop at the closing throttle restriction 71 is sufficient to engender a strong closing force. Hence the pressure loss at the closing piston 43 can be reduced, and at the same time the closing speed can be increased.

The closing piston 43 is guided axially in the injector housing. Between the closing piston 43 and the nozzle needle 17, there is play in the radial direction, so that seizing of the nozzle needle cannot occur for instance if the nozzle needle guide 63 and the region of the injector housing 15 in which the closing piston 43 is disposed have a slight error of alignment.

As an alternative to the exemplary embodiment shown in FIG. 2, in which the nozzle needle 17 is coupled to the control valve 19 via the control piston 27, it would also be possible to couple the control piston 27 and the nozzle needle 17 hydraulically with one another. Alternatively, it is also possible to embody the nozzle needle 17 and the control piston 27 in one piece.

FIG. 3 shows an exemplary embodiment of a closing piston 43 according to the invention. In this exemplary embodiment, the closing piston is embodied as a slit ring. In the non-installed state, the outside diameter of the closing piston 43 can be somewhat greater than the diameter D₁ of the injector housing 15, so that the closing piston 43 is inserted into the injector housing with a certain prestressing. The slit 83 is dimensioned such that it takes on the task of the closing throttle restriction. As a result of the prestressing of the closing piston 43 in the bore of the injector housing 15, the closing piston 43 always rests without play in the injector housing 15, even if over the course of time, wear should occur at the closing piston 43 or in the injector housing.

1-14. (canceled)

15. An injector for an injection system of an internal combustion engine, comprising
a nozzle needle and a control valve, the nozzle needle being guided in an injector housing and cooperating with a nozzle needle seat of the injector housing,
a high-pressure chamber disposed between the control valve and the nozzle needle seat,
a closing piston provided on the nozzle needle or on a control element, the closing piston dividing the high-pressure chamber into a first region and a second region, wherein the two regions of the high-pressure chamber communicate hydraulically by means of a closing throttle restriction.

16. The injector as defined by claim 15, wherein the closing piston is guided in a radial direction in the injector housing and between the closing piston and the nozzle needle, there is play in the radial direction.

17. The injector as defined by claim 15, wherein the closing piston has a slit and the slit is embodied as a closing throttle restriction.

18. The injector as defined by claim 16, wherein the closing piston has a slit and the slit is embodied as a closing throttle restriction.

19. The injector as defined by claim 15, wherein an outside diameter of the closing piston is greater than a diameter of the nozzle needle in the region of the nozzle needle guide.

20. The injector as defined by claim 18, wherein an outside diameter of the closing piston is greater than a diameter of the nozzle needle in the region of the nozzle needle guide.

21. The injector as defined by claim 15, wherein a shoulder is embodied on the nozzle needle, the closing piston is braced against the shoulder, and the shoulder is embodied as a sealing seat cooperating with the closing piston.

22. The injector as defined by claim 20, wherein a shoulder is embodied on the nozzle needle, the closing piston is braced against the shoulder, and the shoulder is embodied as a sealing seat cooperating with the closing piston.

23. The injector as defined by claim 21, wherein the sealing seat is embodied as a flat sealing seat.

23. The injector as defined by claim 22, wherein the sealing seat is embodied as a flat sealing seat.

25. The injector as defined by claim 15, wherein the control valve, in a first switching position, interrupts a hydraulic communication between a control chamber and a fuel return, and the control valve, in a second switching position, establishes a hydraulic communication between the control chamber and a fuel return.

26. The injector as defined by claim 15, wherein the control element defines the control chamber and the nozzle needle and the control element are coupled to one another.

27. The injector as defined by claim 24, wherein the control element defines the control chamber and the nozzle needle and the control element are coupled to one another.

28. The injector as defined by claim 15, wherein the control piston has a through bore and on an end toward the control chamber has a sealing edge surrounding the through bore, and a flat seat cooperating with the sealing edge is embodied on a control chamber body of the control valve.

29. The injector as defined by claim 28, wherein the valve body and the control chamber body are embodied in one piece.

30. The injector as defined by claim 15, wherein the control element and a nozzle needle are embodied in one piece.

31. The injector as defined by claim 15, wherein a closing spring is provided between the control chamber body and the control element or the nozzle needle; and that the closing spring subjects the control element to a force which seeks to move the nozzle needle in the direction of the nozzle needle seat.

32. The injector as defined by claim 27, wherein a closing spring is provided between the control chamber body and the control element or the nozzle needle; and that the closing spring subjects the control element to a force which seeks to move the nozzle needle in the direction of the nozzle needle seat.

33. The injector as defined by claim 29, wherein the closing spring is braced at least indirectly against the closing piston.

34. The injector as defined by claim 15, wherein the control valve is actuated by an electromagnetic actuator, by a piezoelectric actuator, or hydraulically.
